(19) United States
(12) Patent Application Publication
(10) Pub. No.: US 2025/0100797 A1
(43) Pub. Date: Mar. 27, 2025

(54) Autonomous Mobile Robot Scissor Lift and Robot Arm

(71) Applicant: Somil Jayesh Nishar, Novi, MI (US)

(72) Inventor: Somil Jayesh Nishar, Novi, MI (US)

(21) Appl. No.: 18/371,820

(22) Filed: Sep. 22, 2023

(51) Int. Cl. B65G 1/04; B25J 5/00; B25J 15/06; B65G 1/137; B66F 11/04

(52) U.S. Cl. CPC B65G 1/0492; B25J 5/007; B25J 15/0616; B66F 11/042; B65G 1/1373

(57) ABSTRACT

The present invention discloses an autonomous mobile robot (AMR) scissor lift and robot arm. This is done by incorporating a robotic arm or collaborative robot (cobot) onto an autonomous mobile robot or automated guided vehicle via the use of a scissor lift mechanism. The scissor lift mechanism facilitates height adjustment, enabling the robot arm or cobot robot to effectively retrieve packages from various levels or heights. This will revolutionize the industry by allowing for adjustable shelf heights from which things may be selected and dropped.

### TECHNICAL FIELD

The present invention relates to automation, autonomous systems and robotics, and in particular to an autonomous mobile robot (AMR) scissor lift and robot arm that will revolutionize the industry by allowing for adjustable shelf heights from which things may be selected and dropped.

### BACKGROUND ART

An autonomous mobile robot (AMR) is a self-propelled self-powered mechanism designed to perform repetitive tasks or organizational functions using an internal guidance system. an automated guided vehicles (AGVs) are guided computerized vehicles that use computer software to determine their positioning, movement, and location. Powered by a battery or electric motor, they are able to complete manufacturing, warehousing, loading, and other operations without human interference. Self-powered AGVs can do load transfers, move and stack pallets, complete assemblies, and tow heavy loads, functions previously performed by people. They have improved production efficiency, removed humans from unsafe and potentially dangerous conditions and overcome possible human errors.

Though the term AGV, or automatic guided vehicle, may seem to be self-defining, in actuality, there are multiple ways that AGVs receive their instructions and programming, which include wires implanted in the floor, cameras, radio waves, lasers, or other forms of technology.

AGVs began as a method of towing trailers to speed up production. At the time, they were considered nice conveniences that saved time. During the latter part of the twentieth century, designers explored other ways to use the technology to improve factory conditions, which has led to a wide array of capabilities, uses, and functions for AGV technology.

Buying things online and having them sent to your house is a common practice. It is logistically tough to say the least to fulfill such orders in a timely, correct, and effective way. When a customer completes an online purchase by selecting the “check out” button, the transaction is referred to as a “order.” Items to be delivered to a specific location are itemized in the order. What we term “fulfillment” is the act of “picking” (retrieving) these things from a massive warehouse, placing them on shipping containers, and sending them on their way. Shipping as many products as quickly as feasible is, thus, a crucial part of the order-fulfillment process.

In most cases, orders are fulfilled from a massive warehouse stocked with everything from basic necessities to specialty items. Therefore, one part of fulfilling an order is making trips to the warehouse to get the products that are part of that order. It is also important to have the items that will be distributed eventually delivered to the warehouse and “placed” in storage bins in an organized method throughout the warehouse.

Items that are being sent and received might be housed in separate areas of a massive warehouse and mixed up with many other items. Order fulfillment that relies only on human labor involves extensive walking on the part of the workers, which may be inefficient and slow. Time is inversely proportional to the efficiency of the fulfillment process, which is a function of the quantity of things dispatched per unit time.

Robots may replace people in the workplace or work in tandem with humans to do more in less time. For instance, robots may be programmed to “pick” products from shelves all across the warehouse so that they can be packed and sent.

There is need to develop a system and device that is able to use a fully automated sorting and picking warehouse where AGV/AMR Robot can completely pick the product and send it out to the delivery station without any human intervention.

### OBJECTS OF THE INVENTION

The primary object of the invention is to provide an autonomous mobile robot (AMR) scissor lift and robot arm that will revolutionize the industry by allowing for adjustable shelf heights from which things may be selected and dropped.

The other object of this invention is to reduce the need for manual labor and, by extension, the number of employees required to operate the automated material handling system.

The other object of this invention is to avail a scissor lift mounted on an automated guided vehicles (AGV) and a Robot arm/cobot robot are used to do this to deliver objects.

The other object of this invention is to provide scissor lift mechanism that will aid in altering the height to the rack, shelves, or storage locations where the robot's arm will be sorting and selecting items, and AMR/AGV will help move autonomously across the warehouse.

The other object of this invention is to provide a running the store or warehouse with fully automated machine, comprising an automated material handling system for warehouses or similar commercial premises that store and deliver a wide variety of articles or products, such as commercial items, spare parts, etc.

The automated material handling system of the present invention accomplishes two crucial tasks integral to effective inventory management:
a. taking up full bins of goods from the warehouse racks, most notably for robotically replenishing stock,
b. taking up full bins of goods from the warehouse racks, most notably for robotically replenishing stock, scooping up items one at a time from bins that were already filled with items, and then sorting orders for multiple items.

The following summary is an explanation of some of the general inventive steps for the system, method, architecture and container in the description. This summary is not an extensive overview of the invention and does not intend to limit the scope beyond what is described and claimed as a summary.

### SUMMARY OF THE INVENTION

The present invention describes an autonomous mobile robot (AMR) scissor lift and robot arm that will revolutionize the industry by allowing for adjustable shelf heights from which things may be selected and dropped.

The automated guided vehicles (AGV) or AMR will get to the shelf where the product needs to be picked up, the data would be transmitted to the correct shelf that needs to be opened and then the scissor lift will adjust the height accordingly to the level where the robot arm or cobot robot will do a pick operation, in which they remove goods from shelves and load them onto the tray or torts. Once the task is achieved the shelf will be closed automatically and the AGV/AMR will head out to the outbound delivery station.

The same thing can also be used for sorting packages where the robot can scan the item and then will head to the right shelf where the product is stored and will place the item back into the shelf or storage area.

The preceding summary is intended to serve as an introduction to some embodiments of the invention. It is not meant to be an overview of all inventive subject matter disclosed in this specification. The detailed description that follows and the drawings that are referred to in the detailed description will further describethe embodiments described in the summary as well as other embodiments. Accordingly, to understand all the embodiments described by this document, a full review of the summary, detailed description and drawings is needed.

### BRIEF DESCRIPTION OF THE DRAWING

The novel features believed to be characteristic of the illustrative embodiments are outlined in the appended claims. The illustrative embodiments, however, as well as a preferred mode of use, further objectives, and descriptions thereof, will best be understood by reference to the following detailed description of one or more illustrative embodiments of the present disclosure when read in conjunction with the accompanying drawings.

FIG. 1 shows an autonomous mobile robot (AMR) scissor lift and robot arm showing a robot 6-axis as described in the present invention.

FIG. 2 shows an automated guided vehicles (AGV) or with a product tray on the robot.

FIG. 3 shows autonomous mobile robot (AMR) scissor lift and robot arm and legs as described in the present invention.

FIG. 4 shows an automated guided vehicles or autonomous mobile robot scissor lift and robot arm depicting a rotating tray as described in the present invention.

FIG. 5 shows an automated guided vehicles or autonomous mobile robot scissor lift and robot arm showing a lifting frame cover as described in the present invention.

FIG. 6 shows an automated guided vehicles illustrating mecanum as described in the present invention.

FIG. 7 shows an automated guided vehicles or autonomous mobile robot scissor lift and robot arm with a lifting table top as described in the present invention.

FIG. 8 shows an automated guided vehicle with an automatic cabinet as described in the present invention.

FIG. 9 shows an automated guided vehicle with a drawer as described in the present invention.

FIG. 10 shows an autonomous mobile robot scissor lift and robot arm showing a robot base joint number 1 as described in the present invention.

### DESCRIPTION OF THE PREFERRED INVENTION

In the following detailed description of the invention, numerous details, examples, and embodiments of the invention are described. However, it will be clear and apparent to those knowledgeable in the field that the invention is not limited to the embodiments set forth and that the invention can be adapted for a wider range of applications.

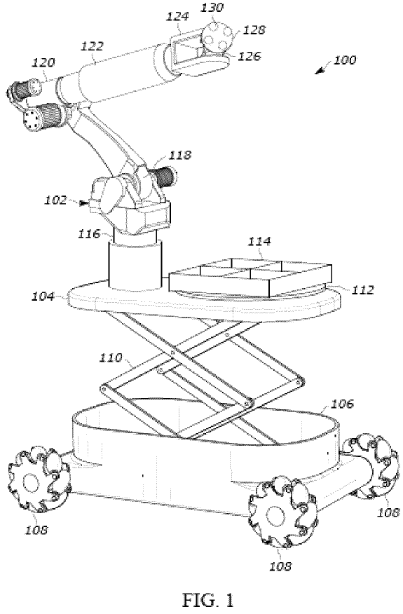

An Automated guided vehicle scissor lift and robot arm, comprising a robotic arm, and a collaborative robot. In FIG. 1-FIG. 10, the automated guided vehicle scissor lift robot arm is enabled to function by incorporating a robotic arm or collaborative robot (cobot) onto an autonomous mobile robot (AMR) or automated guided vehicle (AGV) via the use of a scissor lift mechanism. The scissor lift mechanism facilitates height adjustment, enabling the robot arm or cobot robot to effectively retrieve packages from various levels or heights.

In first embodiment according to FIG. 1, the invention shows an automated guided vehicles (AGV) or autonomous mobile robot (AMR) scissor lift and robot arm showing a robot 6-axis 100. The invention provides two pairs of AGV mecanum 108 as a multi-directional wheel at the base the supports the AGV lifting frame 110 within the lifting frame cover 106 that shields and protects the lift frame 110. The lift frame supports AGV lifting table top 104 which is used for placing robots and product tray 114 on the robot that is placed on the rotating tray base 112 for the products or goods. The said tray also holds AGV lifting table top 104, a place for placing robots and product tray. The tray supports the robot legs 116 on which the robot base joint number 1 is held at the position 102 and joint number 2 as held at position 118. The robot arms joint number 3 at position 120 is linked to the joint number 2 at stage 118 and protrudes as joint number 4 which proceeds as joint number 5 at position 124 prior to terminating as joint number 6 at position 126 of the robot arm 100.

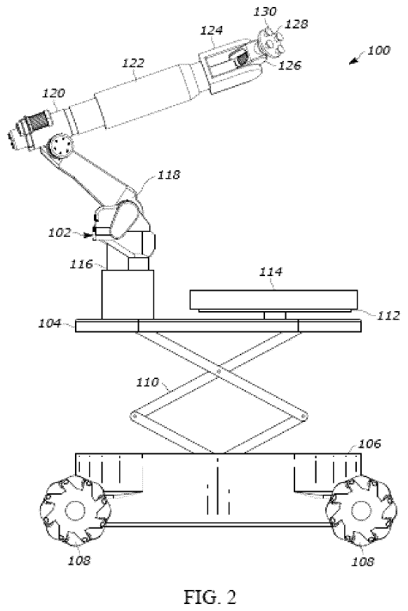

In FIG. 2, the invention describes a side-view of the automated guided vehicle with a product tray on the robot 100 as described in FIG. 1 illustrating a pair of a multi-directional AGV mecanum 108, that supports the lifting frame 110 in the frame 106 and which in turn supports the lifting table top 104. The table supports the goods tray 112 product tray on the robot 114 and so forth.

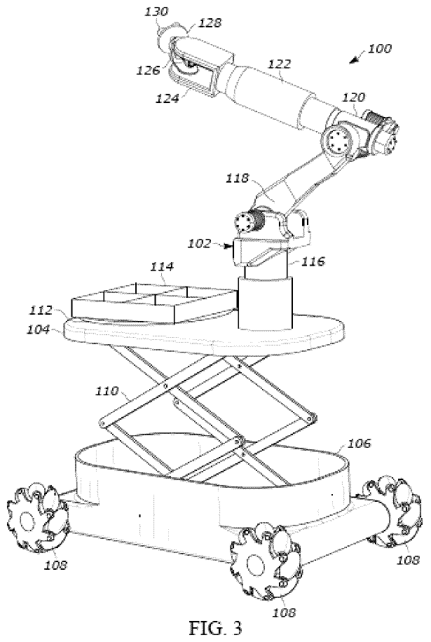

In FIG. 3, the invention describes a right side-view of the autonomous mobile robot (AMR) scissor lift and robot arm 100 with robot legs 116 that attach the robot body to AGV. Besides having the frame cover 106, it also has the lifting frames 110, table top 104, base tray 112 that used to rotate the product trays 114 when needed, robot legs 116 that attach the robot products picked from the outside, among other things. In addition, there exists robot base joint number 1 at position 102 to joint number 6 at position 126 for robot 6-Axisn and a frame for the gripper 128 used to attach the vacuum suction cup 130 being part of the gripper assembly.

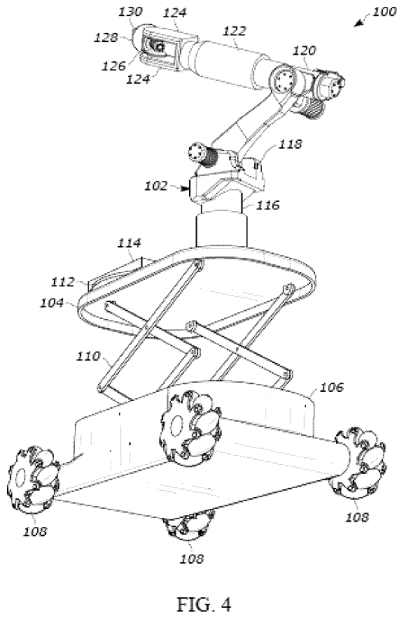

In FIG. 4, the invention describes an automated guided vehicles or autonomous mobile robot scissor lift and robot arm 100 depicting a rotating tray 114 showing the bottom side-view with two pairs of macanum 108 supporting the AGV lifting frame cover 106 among others.

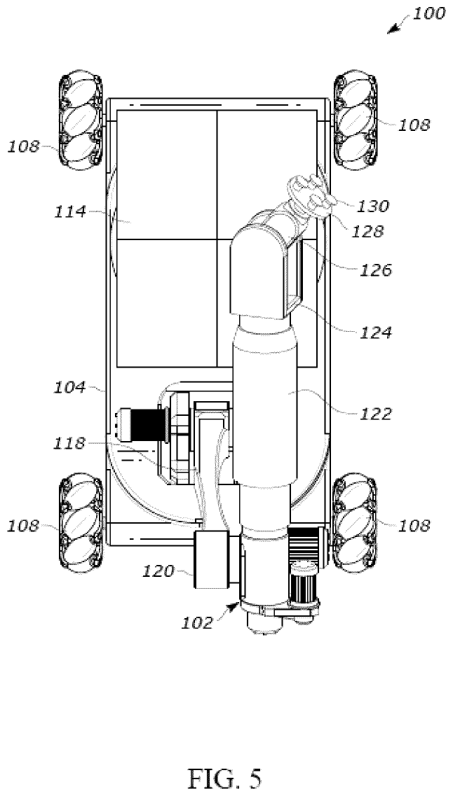

In FIG. 5, the invention describes an automated guided vehicles or autonomous mobile robot scissor lift and robot arm 100 showing a lifting frame cover 106 and two pairs of mecanum 108 as a multi-directional wheel that is connected to the body by frames and robot arm joint number 4 at position 122 and number 6 at position 126.

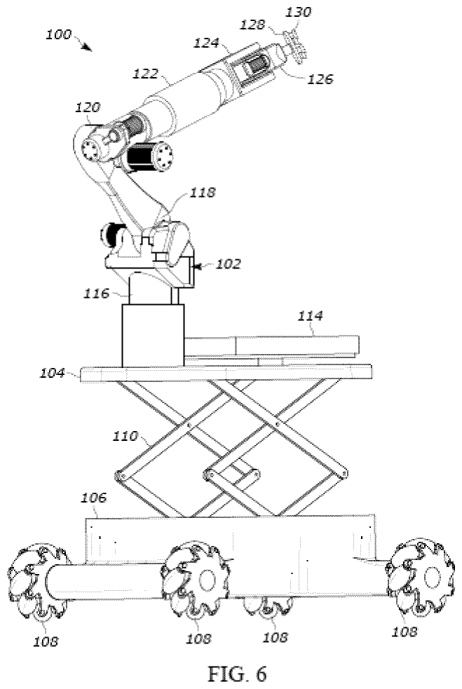

In FIG. 6, the invention describes an automated guided vehicles illustrating mecanum 108, frame cover 106 for shielding and protecting robot legs 116, lifting frame 110 that lifts table with X-shaped structure, the lifting table top 104, product tray on the robot 114 and the robot arm joint number 2 at position 118, number 3 at position 120, joint number 4 at position 122, joint number 5 at position 124 and joint number 6 at position 126 which are collectively referred to as a robot 6-Axis. There is a frame of the gripper 128 that is used to attach the vacuum suction cup 130 at the apex that is part of the gripper assembly.

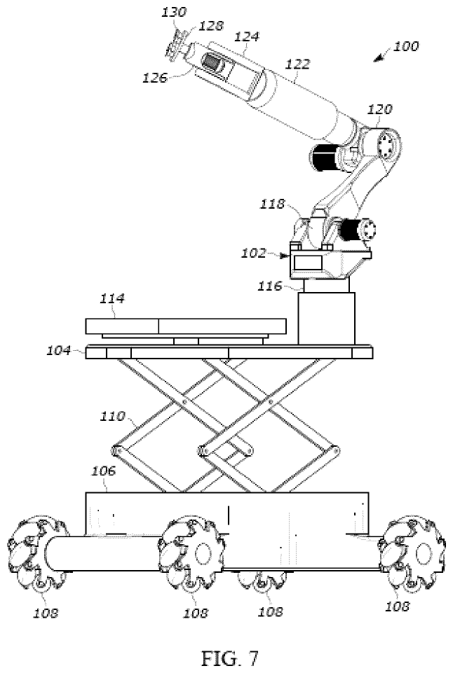

In FIG. 7, the invention describes an automated guided vehicles or autonomous mobile robot scissor lift and robot arm 100 with a lifting table top 104 as described in the present invention. It describes two pairs of mecanun 108 at the bottom that is used as a multi-directional wheel, vacuum cup 130, robot arm-joint numbers 1-6, tray etc.

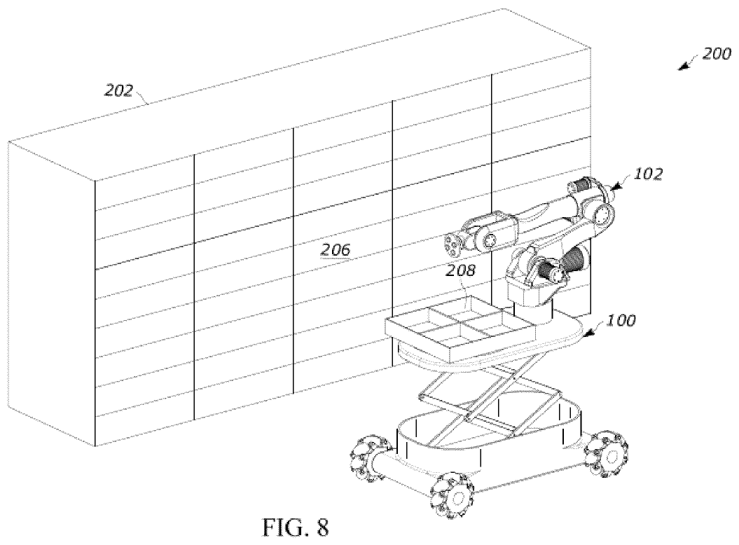

In FIG. 8, the invention describes an automated guided vehicle with an automatic cabinet 202 comprising drawer 206, pairs of mecanum 108 and robot base joint number 1 at position 102 among other features.

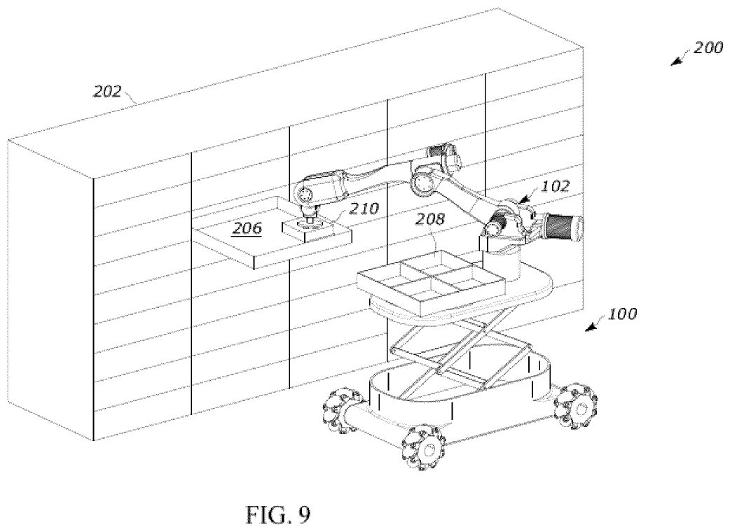

In FIG. 9, the invention describes an automated guided vehicle with a drawer 206 as part of the automatic cabinets 202 that is designed to enable drawers to automatically open and close when receiving a signal, drawer 206 that belongs to automatic cabinets 202, product trays 208 on the robot as feature 114 and is used to place to store robot products picked from the robot outside and the product 210 which is usually transferred from the tray on the robot to the drawer and vice versa as described in FIG. 8 of the present invention.

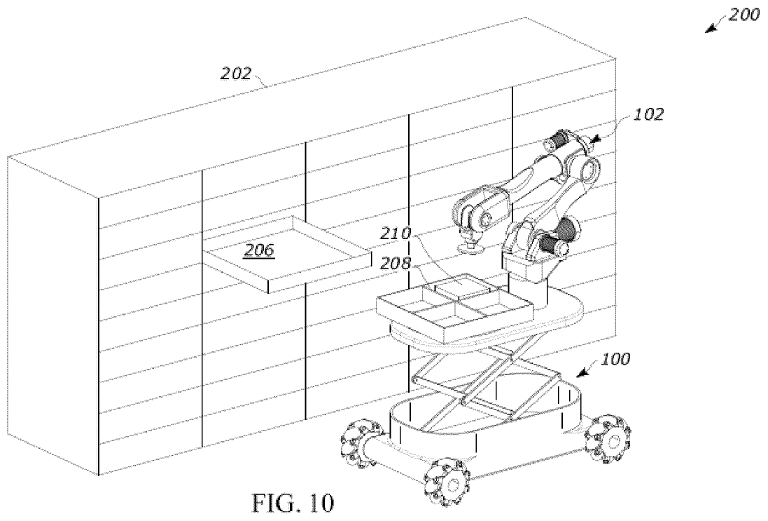

In FIG. 10, the invention describes an autonomous mobile robot scissor lift and robot arm showing a robot base joint number 1 at position 102 and automatic cabinet 202 as described in FIG. 9 of the present invention.

Instead of having a human open the shelf, pick out the item, and place it on the AMR, the AMR/AGV robot 100 comes to the shelf, transmit a signal to open the appropriate shelf, and then the robot arm 102, 118, 120, 122, 124 and 126 can pick out the item, places it on the tort, and close the appropriate shelf. The scissor lift frame 110 is designed to raise and lower a platform onto which a robot arm 100 is mounted that is able to allow for adjustable shelf heights from which things may be selected and dropped and transport the goods 210 to the shipping location and drop it off.

The scissor lift 100 mechanism facilitates height adjustment, enabling the robot arm or cobot robot to effectively retrieve packages from various levels or heights. The robot is able to reduce headcount as the robot arm and can pick the package and places it in the tort wherein the humans can pick the package and place it on AMR/AGV. The robot is able to pick the product that needs to be shipped and will not bring the whole product 210 where in you pick it at outbound and the AMR/AGV have to go back to place the product back into shelf or storage once the individual product is picked.

An automated guided vehicle scissor lift and robot arm 100, comprising a robotic arm and a collaborative robot by incorporating a robotic arm or collaborative robot (cobot) onto an autonomous mobile robot (AMR) crafted in such a way that:
a. the AGV/AMR is able to get to the shelf where the product needs to be picked up,
b. the data is transmitted to the correct shelf that needs to be opened;
c. the scissor lift adjusts the height accordingly to the level where the robot arm or cobot;
d. the robot is able to pick operation, in which they remove goods from shelves and load them onto the tray or torts;
e. once the task is achieved the shelf is closed automatically, and
f. the AGV/AMR is able to head out to the outbound delivery station.

### Advantages

The scissor lift mechanism facilitates height adjustment, enabling the robot arm or cobot robot to effectively retrieve packages from various levels or heights.

The robot reduce headcount as the robot arm will pick the package and place it in the tort where as we have humans to pick the package and place it on AMR/AGV.

it will pick the product that needs to be shipped and will not bring the whole product where in you pick it at outbound and the AMR/AGV have to go back to place the product back into shelf or storage once the individual product is picked

This summary outlines the fundamental aspects of the invention. Additional technical details, specifications, and embodiments will be provided in the detailed description section of the patent application.

While the invention has been described with reference to numerous specific sensors, one of ordinary knowledge in the field will recognize that the invention can be embodied in other specific forms without departing from the spirit of the invention. Specific operations may not be performed in one continuous series of operations, and different specific operations may be performed in different embodiments. Furthermore, the processes or methods could be implemented using several sub-processes, or as part of a larger macro process. Thus, one of ordinary knowledge inthe field would understand that the invention is not to be limited by the foregoing illustrative details, but rather is to be defined by the appended claims.

### INDUSTRIAL APPLICATION

The present invention applies to automation, autonomous systems and robotics. It introduces an automated guided vehicles (AGV) or autonomous mobile robot (AMR) scissor lift and robot arm that will revolutionize the industry by allowing for adjustable shelf heights from which things may be selected and dropped.

What is claimed:

1. An autonomous mobile robot scissor lift and robot arm, comprising:
a robotic arm, and
a collaborative robot.

2. The autonomous mobile robot scissor lift according to claim 1, wherein the robot arm is enabled to function by incorporating a robotic arm or collaborative robot (cobot) onto an autonomous mobile robot (AMR) or automated guided vehicle (AGV) via the use of a scissor lift mechanism.

3. The autonomous mobile robot scissor lift according to claim 2, wherein the scissor lift mechanism facilitates height adjustment, enabling the robot arm or cobot robot to effectively retrieve packages from various levels or heights.

4. The autonomous mobile robot scissor lift according to claim 2, wherein the instead of having a human open the shelf, pick out the item, and place it on the AMR, the AMR/AGV robot comes to the shelf, transmit a signal to open the appropriate shelf, and then the robot arm can pick out the item, places it on the tort, and close the appropriate shelf.

5. The autonomous mobile robot scissor lift according to claim 4, wherein the scissor lift is designed to raise and lower a platform onto which a robot arm is mounted that is able to allow for adjustable shelf heights from which things may be selected and dropped and transport the goods to the shipping location and drop it off.

6. The autonomous mobile robot scissor lift according to claim 5, wherein the scissor lift mechanism facilitates height adjustment, enabling the robot arm or cobot robot to effectively retrieve packages from various levels or heights.

7. The autonomous mobile robot scissor lift according to claim 6, wherein the robot is able to reduce headcount as the robot arm and can pick the package and places it in the tort wherein the humans can pick the package and place it on AMR/AGV.

8. The autonomous mobile robot scissor lift according to claim 7, wherein the robot is able to pick the product that needs to be shipped and will not bring the whole product where in you pick it at outbound and the AMR/AGV have to go back to place the product back into shelf or storage once the individual product is picked.

9. An autonomous mobile robot scissor lift and robot arm, comprising a robotic arm and a collaborative robot by incorporating a robotic arm or collaborative robot (cobot) onto an autonomous mobile robot (AMR) crafted in such a way that:
the AGV/AMR is able to get to the shelf where the product needs to be picked up,
the data is transmitted to the correct shelf that needs to be opened;
the scissor lift adjusts the height accordingly to the level where the robot arm or cobot;
the robot is able to pick operation, in which they remove goods from shelves and load them onto the tray or torts;
once the task is achieved the shelf is closed automatically, and
the AGV/AMR is able to head out to the outbound delivery station.

10. An autonomous mobile robot scissor lift, comprising:
a robot arm and robot arm joints axis;
two pairs of AGV mecanum;
AGV lifting frame;
AGV lifting table;
product tray;
robot legs;
automatic cabinet;
vacuum suction cup;
drawers, and
a product.

11. The autonomous mobile robot scissor lift according to claim 10, wherein the two pairs of AGV mecanum are designed to serve as a multi-directional wheel fixed at the base to support the AGV lifting frame within the lifting frame cover that shields and protects the lift frame.

12. The autonomous mobile robot scissor lift according to claim 10, wherein the lift frame is made to support AGV lifting table top which is used for placing robots and product tray on the robot that is placed on the rotating tray base for the products or goods.

13. The autonomous mobile robot scissor lift according to claim 12, wherein the tray further holds AGV lifting table top 104, a place for placing robots and product tray and capable of supporting the robot legs on which the robot base joints are held.

14. The autonomous mobile robot scissor lift according to claim 10, wherein the two pairs of AGV mecanum acts as pair of a multi-directional wheel designed to support the lifting frame which in turn supports the lifting table top of the table crafted to support the goods tray product tray on the robot.

15. The autonomous mobile robot scissor lift according to claim 14, wherein:
the frame cover is meant to shield and protect robot legs;
the lifting frame that lifts table with X-shaped structure;
the lifting table top used placing robots and product trays, wherein the product tray is utilized to store robot products picked from the outside in or picked from the robot outside, and
the robot arm joints act as robot 6-Axis.

16. The autonomous mobile robot scissor lift according to claim 10, wherein the vacuum suction cup is attached at the apex of the frame as part of the gripper assembly.

17. The autonomous mobile robot scissor lift according to claim 10, wherein the drawer is part of the automatic cabinets that are designed to enable drawers to automatically open and close when receiving a signal, and product trays fixed on the robot and used to place to store robot products picked from the robot outside and the product and which are usually transferred from the tray of the robot to the drawer and vice versa.
